(19) United States
(12) Patent Application Publication
(10) Pub. No.: US 2001/0012535 A1
(43) Pub. Date: Aug. 9, 2001

(54) RECONSTITUTABLE RICE GRAINS

(75) Inventors: PIERRE DUPART, ZUERICH/WITIKON (CH); OTHMAN MOHAMAD YUSSOF, SELANGOR DARUL EHSAN, SHAH ALAM (MY); ERNST H. REIMERDES, CULLY/VILLETTE (CH)

Correspondence Address: PENNIE AND EDMONDS, 1155 AVENUE OF THE AMERICAS, NEW YORK, NY, 100362711

(73) Assignee: PIERRE DUPART

(21) Appl. No.: 09/178,774

(22) Filed: Oct. 26, 1998

(30) Foreign Application Priority Data
Oct. 28, 1997 (EP) 97203350.0

(51) Int. Cl. A23L 1/201

(52) U.S. Cl. 426/618; 426/615; 426/509; 426/516; 426/518; 426/507

(57) ABSTRACT

A process for making reconstitutable rice grains by cooking a mixture of rice flour, water and hydrogenated oil in a cooker-extruder to produce a partly gelatinized mixture, forming the partly gelatinized mixture into rice-grain shaped pieces and then drying and cooling the pieces to room temperature to provide the reconstitutable rice grains. Also, the resulting reconstitutable rice grain product.

### TECHNICAL FIELD

The subject of the present invention relates to process for the preparation of rice grains which may be rapidly reconstituted. The invention also relates to the resultant rapidly reconstitutable rice grains.

### BACKGROUND ART

Usually, quick-cooking reconstitutable rice grains are produced by gelatinizing rice flour and then forming the gelatinized flour into grain shaped pieces.

U.S. Pat. No. 4,769,251 describes in particular a process for the manufacture of quick-cooking rice products in which a mixture comprising 60-80% of rice flour or granules and 20-40% of water is cooked for 20 seconds to 3 minutes by adding steam, in order to increase its temperature from about 150° F. to 210° F. After this preconditioning step, the mixture is introduced into an extruder in which it is sequentially advanced first through a cooking zone, then through a venting zone and a forming zone.

One problem with this process is that a venting zone is necessary to decrease the water content of the mixture which is added at the beginning to decrease the mechanical energy. Also, the final product requires cooking before it can be reconstituted.

European patent application 0226375 describes a process for the preparation of a quick-cooking rice-like product in which rice flour and water are first mixed to form a dough. This dough is then treated in a section of a single or twin screw extruder, preferably in a twin screw extruder, at a temperature below the cooking range of the ingredients. The cooking section of the extruder has four cooking zones of progressively increasing temperature, between 29.4° C. and 104° C., and operates at a pressure of between 6205 kPa and 10342 kPa. The dough is then treated in order to totally gelatinize the starch molecules and to denaturate the proteins. After that the dough is treated in a cooling zone at a temperature between 32.2° C. and 40.5° C., and then sized into dimensions to simulate rice grains which are dried.

One problem with this process is that a large amount of mechanical energy is required to totally gelatinize the starch molecules. Further, the quick-cooking rice-like product is soft after rehydration and does not have the texture of rice grains.

### SUMMARY OF THE INVENTION

The aim of this invention is to provide a simple and rapid process which makes it possible to produce reconstitutable rice grains which keep their grain shape after rehydration without becoming soft. Another aim is to produce rice grains that can rehydrate rapidly and which have a good texture.

Accordingly, in one aspect, the invention provides a process for making reconstitutable rice grains, comprising cooking a mixture of rice flour, water and hydrogenated oil in a cooker-extruder operated at about 100-500 rpm and at a temperature of about 70-150° C., to produce a partly gelatinized mixture, forming the partly gelatinized mixture into rice grain shaped pieces and then drying and cooling the pieces to room temperature to provide reconstitutable rice grains.

### DETAILED DESCRIPTION OF THE INVENTION

It was surprisingly found that this process makes it possible to produce rapidly reconstitutable rice grains without requiring a large amount of energy. These reconstitutable rice grains have the advantage of having pores but not cracks on their surface to allow a quick rehydration with good texture. Furthermore, the reconstitutable rice grains of the invention have the advantage of being resistant to bacteriological contamination.

In order to make use of invention, the extruder cooker is preferably operated at about 120-200 rpm and at a pressure equal or more than 20 bar. Preferably the pressure is about 80-160 bar.

Before extrusion cooking, the rice flour can be treated to decrease bacteriological contamination, especially Bacillus cereus.

In the present invention, the mixture can contain different qualities of rice flour. This permits a larger range of final textures of the instantly reconstitutable rice grains.

The mixture can also contain about 2-11% hydrogenated oil, with respect to the total weight content of the rice flour. It is possible to use, as the hydrogenated oil, coconut oil, soybean oil, cottonseed oil, palm oil or palm kernel oil, so as to decrease the friction during the extrusion-cooking and to control the water absorption of the reconstituted rice grains. If too much oil is added in the mixture, the reconstitutable rice grains do not absorb water very well during rehydration.

In the invention the mixture can also contain 12-25% water. If the amount of water is more than 25%, the mixture is likely to stick in the extruder-cooker. If the amount of water is below 12%, there is too much mechanical energy during the extrusion-cooking and the mixture gelatinizes totally.

According to the invention the mechanical energy used during the extrusion-cooking is preferably less than or equal to 115 watt per kilogram of the mixture, in order not to gelatinize the starch fraction of the rice flour to more than 85% and to form extrudates in a shape of rice grains. During the extrusion-cooking, the level of mechanical energy used is very low owing to the quantity of water and the quantity of oil contained in the mixture.

A desirable extruder-cooker for the practice of the process of this invention is a twin screw extruder-cooker in which the processing section can be made up of two identical intermeshing screws, rotating in the same direction in the bore of a fixed barrel to produce different amount of compression and rates of flow of the ingredients within the extruder barrel.

In preferred embodiments, the extruder-cooker has a 600 to 1700 millimeter diameter barrel with 3 to 8 heating zones, a mixing zone, and 1 to 3 cooling zones.

The mixture is forced through the barrel where the ingredients are mixed, compressed and cooked. The mixture is formed at the end of the barrel and exits as instantly reconstitutable rice grains with pores on their surface.

At the end of the barrel, an excess of steam is released so as to increase the porosity of the instantly reconstitutable rice grains.

On account of the conditions of the extrusion-cooking, bacteriological contamination is reduced during this stage.

If desired, it is possible to add to the mixture aroma, spices and/or coloring agents before or after the extrusion-cooking. It is possible to use as the aroma, chicken, beef, pork, tomato, red pepper, green pepper and/or mushroom. It is possible to use paprika, pepper and/or curry as the spices.

It is possible to add about 0.2 to 2.5% of hydrocolloids, such as alginates, guar or xanthan gum, to the mixture before or after the extrusion-cooking. This increases the quality of the texture of the instantly reconstitutable rice grains. Preferably, alginates which can be extracted from seaweed, such as Laminaria hyperborea or Laminaria digita.

It is possible to fry the pieces before drying them to increase the amount of oil in the final product. This delays the rehydration of the reconstitutable rice grains in food products, such as soup. In this case, the rice will be not an instantly reconstitutable rice.

The instantly reconstitutable rice grains are dried before being cooled to room temperature. The instantly reconstitutable rice grains are preferably dried to reduce their moisture content to below 11%.

In another aspect, this invention provides rapidly reconstitutable rice grains comprising a partly gelatinized matrix of a rice flour which contains a hydrogenated oil. The rice grains reconstitute instantly in hot water and have a good texture. Preferably the rice grains are instantly reconstitutable in hot water.

The instantly reconstitutable rice grains according to the invention have pores on their surface to allow quick rehydration.

The density of the instantly reconstitutable rice grains is about 0.3-0.7 kg/1. The lower the density, the higher the porosity and the faster the rehydration. The value of water uptake after about 2 to 6 mm of rehydration is about 0.70-3.2 g per g of reconstitutable rice grains. The lower the mechanical energy, the lower the water uptake during rehydration and the harder the reconstitutable rice grains.

### EXAMPLES

The preparation process and the rice grains according to the invention are described in more detail in the examples below where the percentages are given by weight, except when otherwise indicated.

### Example 1

A mixture containing 74 kg of rice flour, 0.8 kg of salt, 12.9 kg of water and 3.4 kg of soybean oil is extrusion-cooked in twin screw extruder of 1200 millimeters in length. The extrusion-cooker is operated at 180 rpm and the pressure in the extruder-cooker is 154 bar.

During the extrusion-cooking, the mixture is heated in 3 zones at 50° C., 110° C. and 115° C., mixed and then cooled in 2 zones at 50° C. and 60° C. The mixture is then extruded in the shape of rice grains.

After the extrusion-cooking, the instantly reconstitutable rice grains are dried until their moisture content decreases to 5%. The density of the instantly reconstitutable rice grain is 0.58 kg/1.

The instantly reconstitutable rice grains are then cooled to room temperature before being packaged in a hermetically closed plastic sachet and then stored at room temperature.

### Example 2

A mixture containing 125.65 kg of rice flour, 0.63 kg of salt, 0.4 kg of sodium biphosphate, 29 kg of water and 12.48 kg of soybean oil is extrusion-cooked in twin screw extruder of 1500 millimeters in length. The extrusion-cooker is operated at 217 rpm and the pressure in the extrusion-cooker is 166 bar.

During the extrusion-cooking, the mixture is heated in 2 zones at 80° C. and 100° C., mixed and then cooled in 2 zones at 15° C. and 10° C. The mixture is then extruded in the shape of rice grains.

After the extrusion-cooking, the rice grains are dried and cooled as described in Example 1.

The density of the reconstitutable rice grain is 0.38 kg/1.

### Example 3

A mixture containing 122.34 kg of rice flour, 0.62 kg of salt, 0.4 kg of sodium biphosphate, 1.24 kg of alginate, 29 kg of water and 12.49 kg of soybean oil is extrusion-cooked in twin screw extruder of 1500 millimeters in length. The extrusion-cooker is operated at 218 rpm and the pressure in the extruder-cooker is 126 bar.

During the extrusion-cooking, the mixture is heated in 2 zones at 80° C., mixed and then cooled in 2 zones at 50° C. and 40° C. The mixture is then extruded in the shape of rice grains.

After the extrusion-cooking, the rice grains are dried and cooled as described in Example 1.

The density of the instantly reconstitutable rice grain is 0.53 kg/1.

### Example 4

A mixture containing 100 kg of rice flour, 0.5 kg of salt, 11.8 kg of water and 2.4 kg of palm oil is extrusion-cooked in twin screw cooker extruder of 1200 millimeters in length. The extrusion-cooker is operated at 160 rpm.

During the extrusion-cooking, the mixture is heated in 3 zones at 80° C., 110° C. and 120° C., mixed and then cooled in 2 zones at 50° C. and 46° C. The mixture is then extruded in the shape of rice grains.

After the extrusion-cooking, the reconstitutable rice grains are dried until their moisture content decreases to 5%.

The reconstitutable rice grains are then cooled to room temperature before being packaged in a hermetically closed plastic sachet and then stored at room temperature.

### Example 5

A curried rice dish is produced using instant reconstitutable rice grains prepared in a manner similar to that described in Example 1.

To do this, 73% of rice grains according to the invention, 12% of maltodextrin, 10% of dried vegetables, 3.6% of curry powder, 0.4% of yeast extract and 1% of salt are mixed together.

This mixture is poured into a cup to which hot water is added. The rice grains reconstitute instantly to provide a curried rice dish with a good taste and a nice texture. After 2 to 5 min of soaking, this food preparation can be eaten.

### Example 6

Vegetable porridge is produced using instantly reconstitutable rice grains prepared in a manner similar to that described in Example 1.

50 g of instantly reconstitutable rice grains and 15 g of a spice mixture are mixed together. The spice mixture contains 11.8% of salt, 0.02% of garlic, 0.08% of pepper powder, 3.3% of sodium monoglutamate, 4.5% of corn starch, 3.8% of sugar, 2% of onion powder, 65.5% of potato flakes, 5% of dehydrated carrots, 2% of dehydrated onions and 2% of dehydrated parsley.

Boiling water is added to this preparation which is soaked for 2 to 5 mm, before the consumption. The instantly reconstitutable rice grains in this vegetable porridge have a nice texture and a good taste.

What is claimed is:

1. A process for the preparation of reconstitutable rice grains comprising:
cooking a mixture of rice flour, water and hydrogenated oil in a cooker-extruder operated about at about 100-500 rpm and at a temperature of about 70-150° C. to produce a partly gelatinized mixture,
forming the partly gelatinized mixture into rice-grain shaped pieces, and
drying and cooling the pieces to room temperature to provide the reconstitutable rice grains.

2. The process according to claim 1, in which the mixture contains about 12-25% of water and about 2-11% of hydrogenated oil with respect to the total weight of the rice flour.

3. The process according to claim 1, in which the extrusion cooking uses an amount of mechanical energy which is less than or equal to 115 watt per kilogram of the mixture.

4. The process according to claim 1 which further comprises adding aroma, spices or coloring agents to the mixture before or after the extrusion cooking step.

5. The process according to claim 1 further comprises adding about 0.2 to 2.5% of hydrocolloids to the mixture before or during the extrusion cooking step.

6. The process according to claim 1 further comprises frying the rice-grained shaped pieces before the drying step.

7. The process according claim 1, in which the partly gelatinized mixture has a degree of gelatinization of not more than 85%.

8. Rapidly reconstitutable rice grains comprising a partly gelatinized matrix of a rice flour which contains a hydrogenated oil.

9. Rapidly reconstitutable rice grains which have surface pores.

10. Rapidly reconstitutable rice grains which have a density of about 0.3 to 0.7 kg/1.

11. Rapidly reconstitutable rice grains produced by the process of claim 1.

12. The rice grains of claim 11 having surface pores.

13. The rice grains of claim 11 having a density of about 0.3 to 0.7 kg/l.
